(19) United States
(12) Patent Application Publication
(10) Pub. No.: US 2004/0210914 A1
(43) Pub. Date: Oct. 21, 2004

(54) Method of generating a remote communication interface for resource description framework (RDF) based information

(76) Inventors: Jason A. Kinner, Marlton, NJ (US); Richard Friedman, Cherry Hill, NJ (US); Joseph J. Snyder, Shamong, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,868

(22) Filed: Apr. 17, 2003

(51) Int. Cl. G06F 9/44

(52) U.S. Cl. 719/330; 719/328

(57) ABSTRACT

The specification may disclose a method of reading, by a compiler program, a Resource Description Framework (RDF) based input source, generating implementation by the compiler to access information coded based on the RDF model, and generating an interface to allow remote access to the information coded based on the RDF model over one of several possible systems and/or protocols.

### BACKGROUND

Resource Description Framework (RDF), as defined by the World-Wide Web Consortium (W3C), may be a model for storing information. More particularly, the RDF model may be designed for storing of information about information—METADATA. METADATA in the RDF model is grouped using a logical triple. In its simplest form, the triple may comprise a subject, a predicate and an object. For example, the statement “Leslie is 34 years old” may be broken down into the triple subject=Leslie, predicate=age, and object=“34.” Thus, the predicate that links the subject “Leslie” to the object “34” may be the property ‘age’. In more technical terms, the triple of the RDF model may be defined by a resource (subject), property (predicate), and object. Although the resource in the simple example given above was “Leslie,” in the RDF model a resource may be anything which may be assigned a Universal Resource Identifier (URI). One example of the resource that may be assigned an URI is a document posted to the world-wide web. A document with a URI may be as simple as a digital image, or may be as complex as a series of commands read by a web browser to create a viewable web page.

The RDF model may not define properties or predicates; rather, the RDF model may only define the relationship of storing METADATA in the form of a triple. Thus, the general population may be free to define any series of properties which may be relevant to their particular genre of subjects. Each of these defined set of properties may be referred to as a schema, a RDF schema, or a “namespace.”

Although the general population may be free to define RDF schemas, there are previously defined, and publicly available, schemas for particular resources. For example, one organization has created the Dublin Core METADATA schema directed to properties of internet documents, such as web documents viewable with a web browser, pictures posted to the web, and the like. The Dublin Core schema may define fifteen properties, such as title, author, publisher, other agent (such as editors, transcribers or illustrators who have made significant intellectual contribution), date, object type, and the like. However, other schemas may be created in which properties, though facially the same, have different meanings. Thus, for example, under the Dublin Core schema ‘Date’ may have a particular meaning, namely, the date of publication. Under other schemas, ‘Date’ may be defined in other ways, such as date of creation of the work.

The RDF model, as well as the various schema that have been produced or may be produced, may not be a programming language. Rather, METADATA information may be coded in eXtensible Markup Language (XML). For the METADATA to be useful, user programs may need to access METADATA. For example, a search engine program may need to search through the METADATA in an attempt to identify a document based on search criteria. In some cases, the METADATA, coded in an RDF framework, may be available on the same machine as the search engine. In other cases, however, the METEADATA may reside at a physical or logical distance, whether on the same computer or on a computer in another part of the world. Thus, what may be needed in the art is a communication scheme for access to METADATA.

### SUMMARY OF SOME OF THE PREFERRED EMBODIMENTS

The problems noted above may be solved in large part by a method that may comprise reading a Resource Description Framework (RDF) based input source by a first compiler, generating an application program interface (API) based on the RDF input source by the first compiler, and generating at least a portion of a remote communication interface by second compiler to allow remote access to the API.

Other embodiments of the invention may comprise a computer readable medium comprising an executable program adapted to perform tasks such as reading a RDF leveraged input source, generating a list of functions operative on the properties of the RDF leveraged input source, generating a set of implementations based on the properties of the RDF leveraged input source and generating at least a portion of a remote communication interface to allow remote access to the implementations.

### BRIEF DESCRIPTION OF THE DRAWINGS

For a detailed description of the embodiments of the invention, reference will now be made to the accompanying drawings in which:

FIG. 1 may illustrate, in block diagram form, the effective interaction between a remote client and a server in accordance with embodiments of the invention;

FIG. 2 may illustrate a more comprehensive block diagram of the components in a client/server communication in accordance with embodiments of the invention;

FIG. 3 may illustrate the interaction of the various components for use with Enterprise JavaBeans™ as a remote communication system in accordance with embodiments of the invention;

FIG. 4 may illustrate the interaction of the various components for use with a Common Object Request Broker Architecture (CORBA) system as a remote communication system in accordance with embodiments of the invention; and

FIG. 5 may illustrate the interaction of the various components for use with a Simple Object Access Protocol (SOAP) as a remote communication protocol in accordance with embodiments of the invention.

### NOTATION AND NOMENCLATURE

Certain terms are used throughout the following description and claims to refer to particular components and systems. As one skilled in the art will appreciate, computer and software companies may refer to a component by different names. This document does not intend to distinguish between components and systems that differ in name but not function. In the following discussion and in the claims, the terms “including” and “comprising” are used in an open-ended fashion, and thus should be interpreted to mean “including, but not limited to . . . ”.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

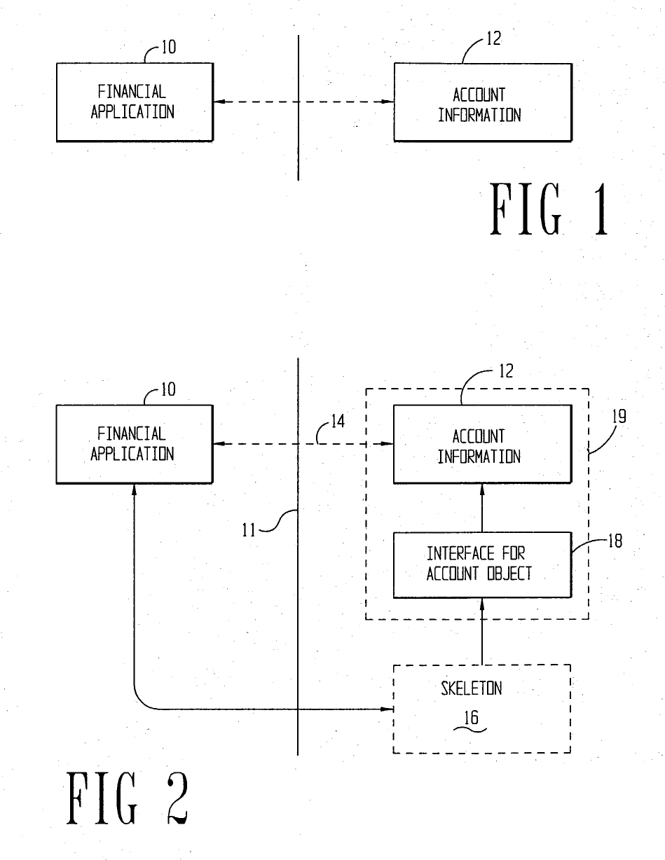

Embodiments of the present invention may be directed to underlying software interoperability for access by remote (physically or logically) applications to METADATA coded under the RDF model. FIG. 1 may illustrate, in a high level block diagram form, the effective interaction between an exemplary remote application (financial application 10) and its target account information 12 METADATA. Before proceeding it should be understood that the financial application illustrated in FIG. 1 may be only a single example of possible systems to utilize the embodiments of the invention, and thus should not be construed as limiting the applicability of the embodiments of the invention. In the system of FIG. 1, the financial application 10 may access the account information 12 across a communication network 11, such as the world-wide web, as illustrated by dashed line 14.

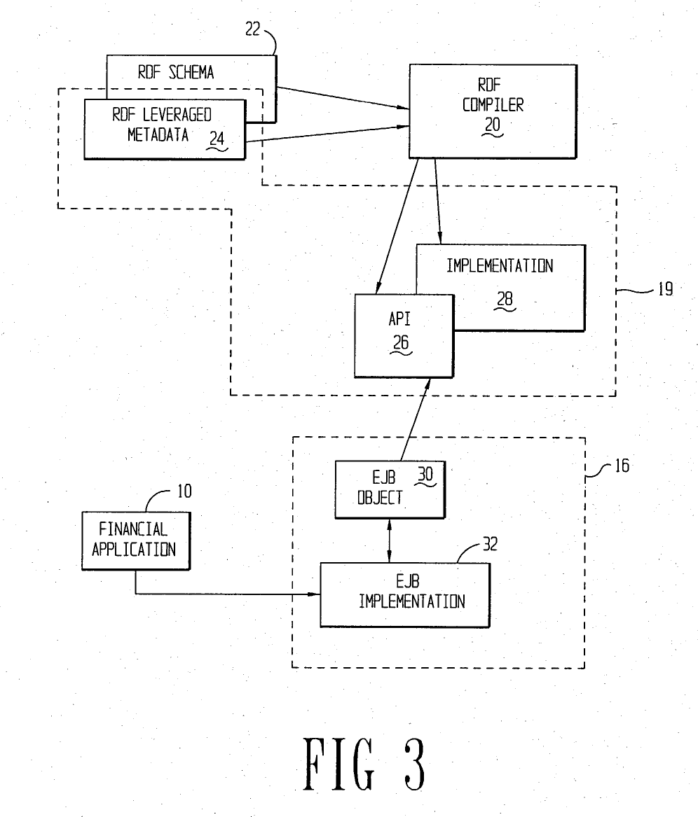

FIG. 2 may illustrate a more comprehensive block diagram of embodiments of the present invention. In particular, while the exemplary financial application 10 may effectively communicate with the account information 12, as illustrated by dashed line 14, the communication may need to pass through several layers of systems and/or protocols in, for example, a client/server communication. In a broad sense, the remote application, for example the financial application 10, may facilitate desired communication through a skeleton 16. As the name may somewhat imply, the skeleton 16 may provide a framework for communication. Skeletons 16 that may be used in embodiments of the invention are discussed more thoroughly below.

Still referring to FIG. 2, in embodiments of the invention the skeleton 16 may facilitate the communication of the remote application by communication with an interface 18, which in turn may access information in the METADATA coded under the RDF model, RDF leveraged METADATA. In the system illustrated in FIG. 2, the RDF leveraged METADATA may be the account information 12, and the interface 18 may provide the interface for the account object. Together, the RDF leveraged METADATA (e.g., account information 12) and the interface 18 may form what is known as a “stub” 19. Thus, remote applications may access information by way of skeletons and stubs.

Co-pending application serial number______ filed______ and titled, “METHOD OF GENERATING AN APPLICATION PROGRAM INTERFACE FOR RESOURCE DESCRIPTION FRAMEWORK (RDF) BASED INFORMATION,” (Client Ref. No. 100203208-1 (Atty. Docket No. 2162-04500)) which is commonly assigned with this specification, which disclosure is incorporated herein by reference as if reproduced in full below, may discuss an RDF compiler that takes as input an RDF based source document, and may produce an application program interface (API) and related implementation, both possibly in native-language form. From the API and implementation, programmers (and the applications they create) may thus access METADATA within RDF leveraged METADATA sources. However, in cases where the remote applications may need access to RDF leveraged METADATA sources, there may be a need for additional abstraction to facilitate the communication.

Referring now to FIG. 3, there may be illustrated more specific embodiments of the inventions. In particular, embodiments of the invention may comprise an RDF compiler 20, which may be an executable program programmed in any available programming language. The compiler 20 may be designed and coded such that it takes as input data a RDF input source, such as a RDF schema 22 or a RDF leveraged METADATA document 24. From one or more of these input sources, the compiler 20 may produce an API 26 from the RDF properties defined in the input source, and may also produce a set of native-language implementations 28. For a more detailed description of this aspect of the embodiments of the invention, reference may be made to the above-noted patent titled, “METHOD OF GENERATING IMPLEMENTATIONS FOR RESOURCE DESCRIPTION FRAMEWORK (RDF) BASED INFORMATION.”

In various embodiments of the invention, the compiler 20 may thus create a portion of the stub 19 (in particular the interface 18) (FIG. 2), and may also generate at least a portion of a skeleton 16. Referring again to FIG. 3, the compiler 20 of embodiments of the invention may, in addition to generating the API 26 and implementation 28, generate in at least some embodiments an Enterprise JavaBeans™ (EJB) object 30. EJB may be a software component technology for system creation. Rather than a programmer starting with a blank page, coding an entire system, and then de-bugging such a system, EJB may allow the program to piece together previously written and tested software “components” to perform the desired task. EJB may be an open-source component technology, thus allowing integration of third party components to form an overall system. Such a software development system may thus reduce overall develop and testing time. For more information regarding EJB, reference may be made to the Enterprise JavaBeans™ proposed final draft, available at http://java.sun.com/products/eib/docs.html, which final draft is incorporated herein by reference as if reproduced in full below.

Referring still to FIG. 3, in at least some embodiments of the invention the compiler 20 may create a Java language based EJB object 30, which may be part of the skeleton 16. From the EJB object, the EJB system may create the EJB implementation 32. The combination of the EJB object 30 and the EJB implementation 32 may thus form the skeleton 16, through which a remote EJB leveraged application, such as, but without limitation, financial application 10, may communicate to a stub 19.

As discussed in the above-noted, commonly-assigned patent, the compiler 20 may produce the native-language API 26 and native-language implementation 28 in any of a variety of now-known, or hereafter created, program languages. These languages may include, but are not limited to Java, C++, C# (C sharp), and the like. The EJB object 30 may be created by the compiler 20 in Java. Thus, either a single compiler 20 may be used to generate the native-language API 26, native-language implementation 28 and Java-language EJB object 30, or different compilers may be used (for example, where the native-language stub 19 components use a language other than Java). The API 26 and implementation 28, once compiled, may provide access to the RDF leveraged METADATA 24 by the remote application through the EJB system.

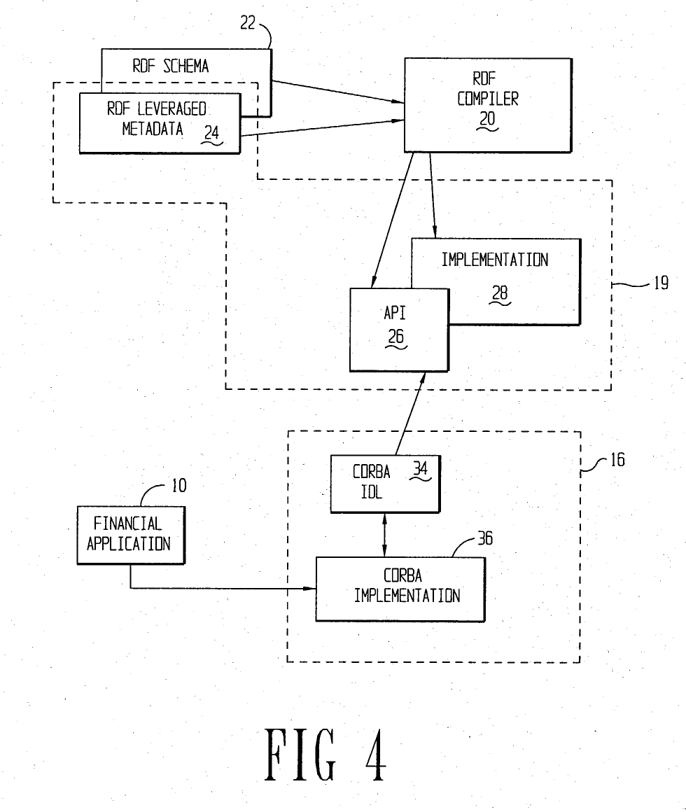

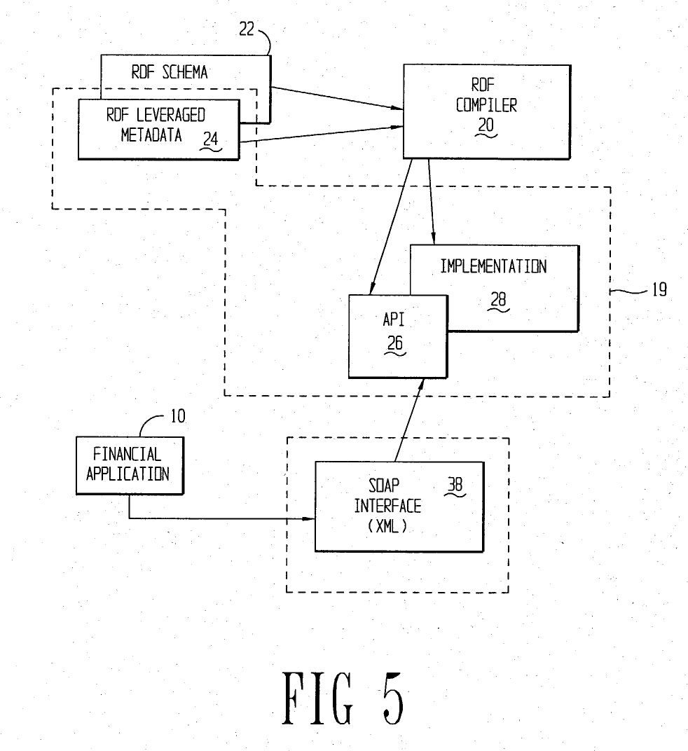

Referring now to FIG. 4, there may be shown further embodiments of the present invention. In particular, FIG. 4 may show the RDF leveraged METADATA 24 or RDF schema 22 as an input source to the compiler 20. The compiler may thus create the native-language API 26 and native-language implementation 28. The compiler 20 may also create portions of the skeleton 16, in particular a Common Object Request Broker Architecture (CORBA) based control document 34, possibly in an Interface Definition Language (IDL) format. CORBA, much like EJB, may be a component technology based system for communication of data to and from clients and objects. While in some cases the clients and objects may reside on the same computer, the standard may transparently allow communication over physical or logical distances. For more information about the CORBA standard, reference may be made to the CORBA specification, available at:

http://www.omg.org/technology/documents/formal/corba_{—}2.htm, which standard is incorporated by reference herein as if reproduced in full below.

In relevant part to the embodiments of the present invention, the object (server) side in a CORBA compliant system may define available services and information by a COBRA control document in IDL. IDL may be a programming language independent operational interface. The underlying communication protocol for a CORBA system may be an InternetInterORB Protocol (IIOP), although CORBA based systems are necessarily limited to this protocol. From the CORBA control document in IDL, the CORBA system may generate a Java-based CORBA implementation for transport of messages. In embodiments of the present invention, and referring to FIG. 4, the compiler 20 may generate a CORBA control document in IDL 34 based on its input source, such as an RDF schema 22 or RDF leveraged METADATA 24. The underlying CORBA system may then generate the Java-based CORBA implementation 36 to facilitate communication from a client, such as a financial application 10. The compiler 20 may have the functionality required to produce the native language components as well as the IDL document, or a second compiler may be used.

Referring now to FIG. 5, there may be shown other embodiments of the present invention. In particular, FIG. 5 may show the RDF leveraged METADATA 24 or RDF schema 22 as an input source to the compiler 20. The compiler may thus create the native-language API 26 and native-language implementation 28. The compiler 20 may also create portions of the skeleton 16, in particular the Simple Object Access Protocol (SOAP) interface 38, based on its input sources. SOAP may be a message based protocol for the exchange of information between clients and objects (between peers in SOAP terminology). For more information about SOAP, reference may be made to the SOAP specification available at http://www.w3.org/TR/SOAP, which is incorporated by reference herein as if reproduced in full below.

Thus, embodiments of the present invention, in particular the compiler 20, may generate the SOAP interface 38, in XML format. A SOAP server (not shown in FIG. 5) reads the SOAP interface 38 and effectively acts to implement remote access by invoking appropriate APIs 26 (and thus their implementations 28) based on requests delivered to the SOAP server from remote clients. Thus, remote systems, such as financial application 10, may communicate with the RDF leveraged METADATA 24 regardless of the type of remote system implemented using the SOAP protocol.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
reading a Resource Description Framework (RDF) based input source by a first compiler;
generating an application program interface (API) based on the RDF based input source by the first compiler; and
generating at least a portion of a remote communication interface by a second compiler to allow remote access to the API.

2. The method as defined in claim 1 wherein generating at least a portion of a remote communication interface further comprises generating the at least a portion of the remote communication interface based on the RDF based input source.

3. The method as defined in claim 2 wherein reading the RDF based input source further comprises reading a RDF schema.

4. The method as defined in claim 2 wherein reading the RDF based input source further comprises reading a database based on an RDF model.

5. The method as defined in claim 1 wherein generating at least a portion of a remote communication interface further comprises generating the at least a portion of the remote communication interface based on the API.

6. The method as defined in claim 1 wherein generating at least a portion of a remote communication interface further comprises generating an Enterprise JavaBean™ object file.

7. The method as defined in claim 1 wherein generating at least a portion of a remote communication interface further comprises generating a Common Object Request Broker Architecture (CORBA) document in Interface Definition Language (IDL).

8. The method as defined in claim 1 wherein generating at least a portion of a remote communication interface further comprises generating a Simple Object Access Protocol (SOAP) interface in extensible Markup Language (XML).

9. The method as defined in claim 1 wherein the first compiler and the second compiler are the same compiler.

10. The method as defined in claim 1 wherein generating the API by the first compiler further comprises generating a Java native-language API by the first compiler.

11. The method as defined in claim 1 wherein generating the API by the first compiler further comprises generating a C++ native-language API by the first compiler.

12. The method as defined in claim 1 wherein generating the API by the first compiler further comprises generating a C# native-language API by the compiler.

13. A computer readable medium comprising an executable program, the executable program adapted to perform tasks when executed, comprising:
reading a Resource Description Framework (RDF) leveraged input source;
generating a list of functions operative on properties of the RDF leveraged input source;
generating a set of implementations based on the properties of the RDF leveraged input source; and
generating at least a portion of a remote communication interface to allow remote access to the implementations.

14. The computer readable medium as defined in claim 13 wherein reading the RDF leveraged input source task of the executable program further comprises reading an RDF schema.

15. The computer readable medium as defined in claim 13 wherein reading the RDF leveraged input source task of the executable program further comprises reading an RDF leveraged METADATA set.

16. The computer readable medium as defined in claim 13 wherein the generating at least a portion of a remote communication interface to allow remote access to the implementations task of the executable program task further comprises generating an Enterprise JavaBeans™ object file to allow remote access to the implementations.

17. The computer readable medium as defined in claim 13 wherein generating at least a portion of a remote communication interface to allow remote access to the implementations task of the executable program task further comprises generating a Common Object Request Broker Architecture (CORBA) document in Interface Definition Language (IDL) to allow remote access to the implementations.

18. The computer readable medium as defined in claim 13 wherein generating at least a portion of a remote communication interface to allow remote access to the implementations task of the executable program task further comprises generating a Simple Object Access Protocol (SOAP) interface in eXtensible Markup Language (XML) to allow remote access to the implementations.

19. A method comprising:
reading a Resource Description Framework (RDF) based input source by a compiler program;
generating an interface by the compiler program;
generating a set of implementations by the compiler program; and
generating at least a portion of a remote interface by the compiler program.

20. The method as defined in claim 19 wherein generating at least a portion of a remote interface by the compiler program further comprises generating an Enterprise JavaBeans™ object file.

21. The method as defined in claim 19 wherein generating at least a portion of a remote interface by the compiler program further comprises generating a Common Object Request Broker Architecture (CORBA) document in Interface Definition Language (IDL).

22. The method as defined in claim 19 wherein generating at least a portion of a remote interface by the compiler program further comprises generating a Simple Object Access Protocol (SOAP) interface in extensible Markup Language (XML).

23. The method as defined in claim 19 wherein reading the RDF based input source further comprises reading a RDF schema document.

24. The method as defined in claim 19 wherein reading the RDF based input source further comprises reading a database based on an RDF model.
